(19) United States
(12) Patent Application Publication
(10) Pub. No.: US 2015/0142405 A1
(43) Pub. Date: May 21, 2015

(54) Method For Simulating The Operation Of An Internal Combustion Engine And Device For Carrying Out The Method

(71) Applicant: MAN Truck & Bus AG, Muenchen (DE)

(72) Inventors: Thomas MALISCHEWSKI, Furth (DE); Björn LUMPP, Neustadt (DE); Joachim WEIß, Oberasbach (DE)

(21) Appl. No.: 14/541,337

(22) Filed: Nov. 14, 2014

(30) Foreign Application Priority Data
Nov. 14, 2013 (DE) 10 2013 018 978.0

(51) Int. Cl. G06F 17/50

(52) U.S. Cl. CPC G06F 17/5009
USPC 703/7

(57) ABSTRACT

A method for simulating the operation of an internal combustion engine, using a single-cylinder test bench device, and a data-processing device executing an engine simulation model which simulates a multi-cylinder internal combustion engine. The engine simulation model determines a simulation value of at least one simulation variable, to be simulated, of the multi-cylinder internal combustion engine, in particular air mass flow and/or exhaust gas recirculation rate on the basis of at least one test bench. operating value, in particular indicated mean pressure and/or exhaust gas temperature, which is detected at a defined test bench operating point of the single-cylinder test bench device by means of a measuring device and fed to the data-processing device.

### CROSS-REFERENCE TO RELATED APPLICATIONS

This application claims the priority of DE 10 2013 018 978.0 filed Nov. 14, 2013, which is incorporated herein by reference.

### BACKGROUND OF THE INVENTION

The invention relates to a method for simulating the operation of an internal combustion engine, to a device for carrying out the method, and to a computer program product for carrying out the method.

During the development of new internal combustion engines, the use of engine simulation models which are close to real conditions is playing an evermore important role. The use of the engine simulation models allows effective evaluation of individual engine concepts even in a very early phase of the engine development so that, for example, the development time and number of prototype parts can be significantly reduced. Use of engine test benches is also significant during the development of internal combustion engines since here, in particular in the case of single-cylinder test benches, for example individual internal combustion engine components can be replaced at low cost and there are extensive setting possibilities for internal combustion engine operating variables such as the air mass flow or exhaust gas recirculation rate. In order to combine the advantages of the engine simulation models and of the engine test benches and to optimize further engine development it is also known to couple an engine test bench to an engine simulation model.

DE 100 20 448 A1 discloses, for example, a method for optimizing the operation of an internal combustion engine in which a full engine test bench is coupled to a physical engine model in order to describe a functional relationship between manipulated variables and target variables of the internal combustion engine. As a result, a database is produced for every operating point of the internal combustion engine, which database permits the manipulated variables to be optimized as a function of the target variables without further use of the engine test bench. The optimization is carried out here exclusively by a computer, as a result of which the optimized manipulated variables can be determined particularly quickly. However, this method has the disadvantage that the functional relationship between the manipulated variables and the target variables can be determined with difficulty or only with insufficient precision. Furthermore, reference is made to the presence of a multi-cylinder full engine.

### BRIEF SUMMARY OF THE INVENTION

An object of the invention is to make available a method for simulating the operation of an internal combustion engine and a device for carrying out the method, by means of which method and device the operation of the internal combustion engine can be simulated easily and/or in a way which is particularly close to real conditions.

The invention relates to a method for simulating she operation of an internal combustion engine, having a single-cylinder test bench device, and having a data-processing device by means of which an engine simulation model which simulates a multi-cylinder internal combustion engine can be executed, wherein the engine simulation model is embodied in such a way that a simulation value of at least one simulation variable, to be simulated, of the multi-cylinder internal combustion engine, in particular air mass flow and/or exhaust gas recirculation rate, is determined by the engine simulation model on the basis of at least one test bench operating value, in particular indicated mean pressure and/or exhaust gas temperature, which is detected at a defined test bench operating point of the single-cylinder test bench device by a measuring device and fed to the data-processing device.

Since the simulation of the internal combustion engine does not take place here solely by the engine simulation model but rather together with the single-cylinder test bench device, a clearly simplified engine simulation model can be used. The at least one test-bench operating value which is detected at the test-bench operating point which is defined, for example, by a rotational speed and injection quantity can also easily be detected by the measuring device and additionally permits particularly realistic simulation of the internal combustion engine. The engine simulation model can therefore determine on the basis of the at least one test bench operating value a simulation value, which is close to real conditions, for the at least one simulation variable of the multi-cylinder internal combustion engine. The simulated internal combustion engine can then be evaluated effectively by the simulation value which is close to real conditions. The engine simulation model which simulates the internal combustion engine can additionally also be modified easily, as a result of which different internal combustion engine components, peripheral conditions or even internal combustion engines can be simulated. The internal combustion engine simulation therefore has a high degree of variability.

In one advantageous embodiment of the method, the simulation value is determined in a simulation value-determining step, wherein the simulation value-determining step is carried out in real time, and wherein after the simulation value-determining step a simulation value-setting step is carried out in which the determined simulation value is set at the single-cylinder test bench device. Carrying out the simulation value-determining step in real time permits the at least one simulation value to be determined within a defined time period. The determined simulation value can therefore be set reliably as a setpoint value at a defined time at the single-cylinder test bench device. Setting the simulation value at the single-cylinder test bench device permits the simulated internal combustion engine to be evaluated particularly easily since the measurable operating values of a plurality of operating variables of the single-cylinder test bench device, for example the emission quantity or indicated mean pressure, have a direct relationship with the corresponding operating values of the simulated multi-cylinder internal combustion engine.

The simulation value-determining step and the simulation value-setting step are preferably carried out repeatedly and alternately one after the other, wherein the simulation value-determining step is carried out often until the fluctuation in the determined simulation values of the at least one simulation variable undershoots a defined threshold value. The alternating execution of the simulation value-determining step and of the simulation value-setting step permits the at least one simulation value to be determined easily and with high precision.

In one embodiment of the method, in each case at least one current test bench operating value is periodically transmitted to the engine simulation model at fixed intervals, preferably every 0.05 to 0.5 seconds, at most preferably every 0.1 seconds, and at fixed intervals, preferably every 0.05 to 0.5 seconds, at most preferably every 0.1 seconds, in each case a simulation value which is newly determined on the basis of the at least one current test bench operating value is transmitted to the single-cylinder test bench device as a setpoint value. The transmission of the at least one current test bench operating value and of the at least one newly determined simulation value in a defined clock time permits reliable and particularly effective determination of the at least one simulation value.

At least one starting value which defines the starting state can preferably be set at the single-cylinder test bench device before the setting of the at least one determined simulation value at the single-cylinder test bench device. On the basis of the starting state of the single-cylinder test bench device, the manipulated value-determining step can be carried out particularly reliably, before the setting of the at least one determined simulation value, a plurality of starting values which define the starting state are preferably set at the single-cylinder test bench device.

In one specific embodiment of the method, a multi-cylinder internal combustion engine can be simulated by working the engine simulation model. In this way, the use of the single-cylinder test bench device is particularly effective.

The invention also relates to a device for simulating the operation of an internal combustion engine, having a single-cylinder test bench device, and a data-processing device which uses an engine simulation model to simulate a multi-cylinder internal combustion engine. A measuring device is provided for detecting a test-bench operating value of the single-cylinder test bench device. The engine simulation model is embodied in such a way that a simulation value of at least one simulation variable, to be simulated, of the multi-cylinder internal combustion engine, in particular air mass flow and/or exhaust gas recirculation rate, is determined by the engine simulation model based on the at least one test bench operating a value, in particular indicated mean pressure and/or exhaust gas temperature, which can be detected at a defined test bench operating point of the single-cylinder test bench device by the measuring device and fed to the data-processing device.

The engine test bench device is coupled to the engine simulation model by the measuring device in such a way that the internal combustion engine can be simulated no longer solely by means of the engine simulation model but also together with the engine test bench device. In this way, as already mentioned, the use of a significantly simplified engine simulation model and a particularly realistic simulation of the internal combustion engine are made possible.

In one specific embodiment, an engine control unit is provided to set at least one test bench operating point of the single-cylinder test bench device. The engine control unit easily permits the at least one test bench operating points to be set. The test bench operating point can preferably be determined by a defined rotational speed and a defined injection quantity. A plurality of test bench operating points of the single-cylinder test bench device can preferably be set by the engine control unit.

In one specific embodiment, the engine test bench device has a compressor device, in particular a compressor, which compresses the intake air of the engine test bench device, wherein the engine simulation model is coupled to the compressor device in such a way that the compression of the intake air can be set and/or adjusted by the engine simulation model. The compressor device permits a high degree of variability during the setting and/or adjustment of the intake air.

The single-cylinder test bench device can preferably have at least one replaceable interchangeable component by means of which the operation, in particular the combustion process, of the single-cylinder test bench device can be set. The interchangeable components permit rapid setting of the single-cylinder test bench device and therefore particularly variable simulation of the internal combustion engine.

In addition, a computer program product is claimed.

The advantageous embodiments and/or developments of the invention which are explained above and/or presented in dependent claims can, with the exception, for example, of the dependencies or incompatible alternatives which are clear in the case, be used individually or else in any desired combination with one another.

### BRIEF DESCRIPTION OF THE DRAWINGS

The invention and the advantageous embodiments and/or developments thereof as well as the advantages thereof are explained in more detail below.

FIG. 1 is a block diagram of a device for simulating the operation of a multi-cylinder internal combustion engine according to an embodiment of the invention; and

FIG. 2 is a flow diagram of a method according to an embodiment of the invention.

### DETAILED DESCRIPTION OF THE PREFERRED EMBODIMENT

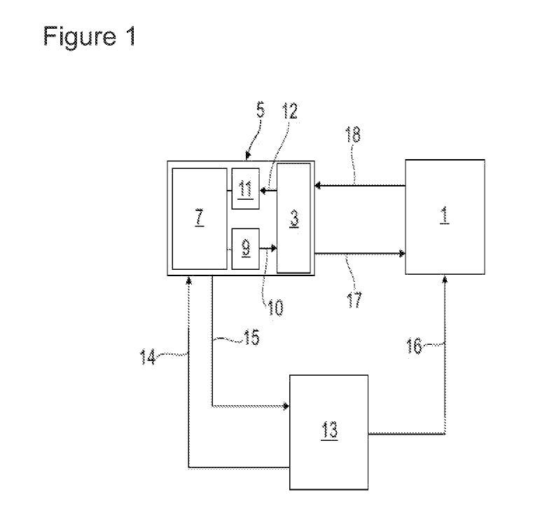

The block elements shown in FIG. 1 are symbolic representations of individual components of a device for simulating the operation of a multi-cylinder internal combustion engine. The device has a data-processing device 1 which executes an engine simulation model which simulates the internal combustion engine in real time. The data-processing device 1 is connected in terms of signaling technology to a test bench PC 3 of a single-cylinder test bench device 5 via a data cable (not shown in the figure). A single-cylinder test bench engine 7 of the single-cylinder test bench device 7 is controlled by means of the test bench PC 3.

In order so control the single-cylinder test bench engine 7, the to bench PC 3 is connected by means of signaling technology to a measuring device 9 and to a setting device 11. By means of she measuring device 9 it is possible to measure operating values 10 of the single-cylinder test bench engine 7 which is in operation, these being here, for example, the rotational speed, indicated mean pressure, injection quantity, exhaust gas temperature, exhaust gas emissions and ambient pressure at different geodetic altitudes. By means of the setting device 11 it is possible to set manipulated values 12 of manipulated variables of the single-cylinder test bench engine 7, here, for example, the air mass flow and exhaust gas recirculation rate, at the single-cylinder test bench engine 7.

From FIG. 1 it is also apparent that the single-cylinder test bench device 5 is connected in terms of signaling technology to an engine control unit 13. A plurality of operating points of the single-cylinder test bench device 5 can be set by means of the engine control unit 13 using a setting signal 14. The operating points are determined, here, for example, by a defined rotational speed and a defined injection quantity. The respective operating point is predefined by means of a predefining signal 15 of the test bench PC 3. Furthermore, the engine control unit 13 is also connected in terms of signaling technology to the data-processing device 1, as a result of which setpoint values stored in the engine control unit 13 for the operation of the single-cylinder test bench device 5, for example the injection quantity, rail pressure, air/fuel ratio or charging pressure can be transmitted to the data-processing device 1 by means of a setpoint value signal 16.

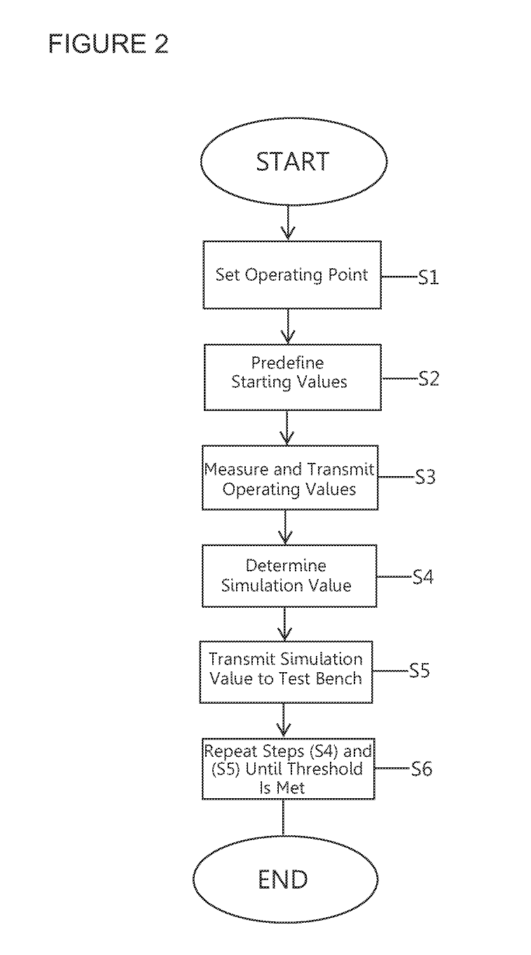

In the text which follows, the individual method steps for simulating the internal combustion engine operation are explained with reference to FIG. 2:

Firstly, an operating point which is predefined by the test bench PC 3 is set at the single-cylinder test bench engine 7 by the engine control unit 13 (S1), wherein starting values which are defined for the settable manipulated values 12 of the single-cylinder to bench engine 7 are predefined (S2). The current operating values 10, measured by means of the measuring device 9, of the single-cylinder test bench 7 are then transmitted to the data-processing device 1 by the test bench PC 3 using an operating value signal 17 (S3). A simulation value-determining step (S4) during which the engine simulation model determines, on the basis of the transmitted operating values 10, simulation values for the air mass flow and the exhaust gas recirculation of the multi-cylinder internal combustion engine is then carried out by means of the data-processing device 1. The simulation values are then transmitted to the test bench PC 3 by means of a simulation value signal 18 and are set in a simulation value-setting step as new manipulated values 12 at the single-cylinder test bench engine 7 by means of the setting device 11 (S5). The simulation value-determining step (S4) and the simulation value-setting step (S5) are carried out repeatedly and alternately one after the other in the further method sequence until the fluctuation of the determined simulation values undershoots a defined threshold value (S6). In this context, the respective current operating value of the single-cylinder test bench engine 7 is transmitted every x seconds from the test bench PC 3 to the data-processing device 1. In addition, the respective newly determined simulation value of the engine simulation model is also likewise transmitted every x seconds from the data-processing device 1 to the test bench PC 3 (x is preferably in a value range from 0.05 to 0.5, particularly preferably being a value of approximately 0.1). If the fluctuation of the simulation values has undershot the defined threshold value, the simulation values can be determined for the next operating point.

### LIST OF REFERENCE NUMERALS

1 Data-processing device
3 Test bench PC
5 Single-cylinder test bench device
7 Single-cylinder test bench engine
9 Measuring device
10 Operating values
11 Setting device
12 Manipulated values
13 Engine control unit
14 Setting signal
15 Predefining signal
16 Setpoint value signal
17 Operating value signal
18 Simulation value signal.

1. A method for simulating the operation of an internal combustion engine, comprising:
executing, by a data-processing device, an engine simulation model which simulates a multi-cylinder internal combustion engine;
detecting at least one test bench operating value at a defined test bench operating point of a single-cylinder test bench device by a measuring device and feeding the detected at least one test bench operating value to the data-processing device; and
determining, by the data-processing device executing the engine simulation model, a simulation value of at least one simulation variable of the multi-cylinder internal combustion engine to be simulated based on the detected at least one test bench operating value.

2. The method according to claim 1, wherein the detected at least one simulation variable is at least one of an air mass flow and an exhaust gas recirculation rate.

3. The method according to claim 1, wherein the at least one test bench operating value is at least one of an indicated mean pressure and an exhaust gas temperature.

4. The method according to claim 1, wherein the simulation value is determined in a simulation value-determining step carried out in real time, and wherein after the simulation value-determining step a simulation value-setting step is carried out in which the determined simulation value is set at the single-cylinder test bench device.

5. The method according to claim 4, further comprising repeatedly and alternately performing the simulation value-determining step and the simulation value-setting step one after the other until a fluctuation in the determined simulation values of the at least one simulation variable to he simulated undershoots a defined threshold value.

6. The method according to claim 5, wherein at least one current test bench operating value is periodically transmitted to the engine simulation model at fixed intervals and in each case a simulation value which is newly determined on the basis of the at least one current test bench operating value is transmitted to the single-cylinder test bench device.

7. The method according to claim 6, wherein the fixed intervals are every 0.05 to 0.5 seconds.

8. The method according to claim 6, wherein the defined clock time are every 0.1 seconds.

9. The method according to claim 1, wherein at least one starting value defining a starting state is set at the single-cylinder test bench device before the setting of the at least one determined simulation value at the single-cylinder test bench device.

10. The method according to claim 1, wherein a multi-cylinder internal combustion engine is simulated by the engine simulation model.

11. A device for simulating the operation of an internal combustion engine, comprising:
a single-cylinder test bench device;
a data-processing device;
an engine simulation model which simulates a multi-cylinder internal combustion engine executable by said data-processing device; and
a measuring device detecting a test-bench operating value of said single-cylinder test bench device at a defined test bench operating point of the single-cylinder test bench device and feeding the detected test-bench operating value to said data-processing device,
wherein the engine simulation model is embodied such that a simulation value of at least one simulation variable of the multi-cylinder internal combustion engine to be simulated is determined by the engine simulation model based on the detected test bench operating value.

12. The device according to claim 11, wherein the at least one simulation variable includes at least one of an air mass flow and an exhaust gas recirculation rate.

13. The device according to claim 11, wherein the test bench operating value includes at least one of a mean pressure and an exhaust gas temperature.

14. The device according to claim 11, further comprising an engine control unit setting the defined test-bench operating point of the single-cylinder bench device.

15. The device according to claim 11, wherein the single-cylinder test bench device includes a compressor device compressing intake air of the single-cylinder test bench device, the engine simulation model being coupled to the compressor device such that a compression of the intake air is one of set and adjusted by the engine simulation model.

16. The device according to claim 11, wherein the single-cylinder test bench device has at least one replaceable interchangeable component by which the combustion process of the single-cylinder test bench device can be set.

17. A non-transitory computer program product storing an engine simulation model for simulating the operation of an internal combustion engine, the engine simulation model comprising processor-executable instructions for:
receiving, at a data-processing device executing the engine simulation model, test bench operating value detected by a measuring device at a defined test bench operating point of a single-cylinder test bench device; and
determining, by the data-processing device, a simulation value of at least one simulation variable of the multi-cylinder internal combustion engine to be simulated based on the at least one test bench operating value.
